(19) United States
(12) Patent Application Publication
(10) Pub. No.: US 2002/0009125 A1
(43) Pub. Date: Jan. 24, 2002

(54) High bandwidth efficient spread spectrum modulation using chirp waveform

(76) Inventor: Zhen Liang Shi, Germantown, MD (US)

Correspondence Address: Richard C. Litman, LITMAN LAW OFFICES, LTD., P.O. Box 15035, Arlington, VA, 22215, US

(21) Appl. No.: 09/877,131

(22) Filed: Jun. 11, 2001

Related U.S. Application Data
(60) Provisional application No. 60/210,744, filed on Jun. 12, 2000.

(51) Int. Cl. H04K 1/00; H04B 15/00; H04L 27/30

(52) U.S. Cl. 375/139

(57) ABSTRACT

A high bandwidth efficient spread spectrum modulation using chirp waveform. The invention provides a method and apparatus for effecting the high bandwidth efficient spread spectrum modulation using chirp waveform. The method involves reducing the data rate by narrowing the bandwidth or by using a smaller set of orthogonal sequences. The apparatus includes a transmitter and a receiver. The transmitter includes an encoder, an interleaver, a serial to parallel convertor, a baseband modulator that modulates the original bits onto each orthogonal sequence, and IF modulation. The receiver includes a down converter, an analog to digital converter, digital correlators, a synchronizer, a parallel to serial convertor, a deinterleaver, and a decoder.

### CROSS-REFERENCE TO RELATED APPLICATION

This application claims the benefit of U.S. Provisional Patent Application Ser. No. 60/210,744, filed Jun. 12, 2000.

### BACKGROUND OF THE INVENTION

1. Field of the Invention

The present invention relates in general to a modulation scheme employing spread spectrum (SS) technology to improve reliability in wireless channel or other transmission media and to increase the bandwidth efficiency of conventional spread spectrum modulation systems.

2. Description of Related Art

Spread spectrum modulation schemes have been used for a long time in military communication due to their capability of anti-jamming, anti-interference, and low interception probability. Within the past ten years, this technology has been widely employed in commercial communication mainly due to the promotion by the Federal Communication Commission (FCC). The FCC specifies three license-free ISM (Industrial, Scientific and Medical) bands for wireless communication with the condition that some forms of spread spectrum techniques have to be used. Technically speaking, the necessity of SS is to reduce the interference from many sources of unpredictable interference, such as microwave ovens, and at the same time, to reduce its own power density in order to minimize the interference to other narrow-band wireless communication systems using the same band. Two common SS schemes are direct sequence (DS) and frequency hopping (FH). The spectrum spreading by a DS system is achieved by multiplying a high speed sequence or code to each information symbol, resulting in a higher bandwidth. At the receiver, the same sequence has to be used to multiply the received signal, which recovers the original data while rejecting other interference since their waveforms never match the defined sequence. The spectrum spreading by an FH system is achieved by transmitting data on many possible different frequency carriers, one at each time slot. It randomly (pseudo randomly) chooses each carrier for the transmission so that the information carrier randomly hops on a wider bandwidth. The hopping pattern is only made available to the receiver to enable reception. Others who do not have the matched hopping pattern cannot demodulate the information.

Strictly speaking, SS modulation is not a bandwidth efficient modulation (compared to narrow-band modulations) due to its use of wider bandwidth to transmit a relative low data rate information. For commercial applications, this is an expensive waste since the bandwidth is limited and customers always demand higher data throughput, such as in wireless multimedia applications. Many researchers have been looking for solutions that can make high speed communication possible and in the mean time, keep the benefit of spread spectrum. One of the techniques is called M-ary orthogonal keying (MOK) modulation. It uses one of 2^{M} orthogonal sequences as the direct sequence. Each of the sequences carries M bits information. At the receiver, 2^{M} correlators have to be implemented to make a decision on which of the sequences is transmitted. The current IEEE standard for a wireless LAN at 2.4 GHz band adopts such a technology named complementary code-shift keying (CCK). Another technique is called orthogonal code division multiplex (OCDM) modulation. Compared to the MOK scheme, it uses M orthogonal sequences, which is much less than 2^{M} used in MOK modulation. Unlike the MOK, OCDM modulates all the M sequences with information data bits and transmit all of them at the same time. Since they are all orthogonal, the receiver can use M correlators, each matching to one of the sequences, to demodulate all the information bits. Obviously, the receiver structure for the OCDM is simpler, because it uses a smaller number of correlators. However, the power of OCDM usually has a larger variation, which may demand a more expensive linear power amplifier at the transmitter. On the frequency hopping side, there is no proposal for high efficient modulation. One of the hot modulation schemes is called orthogonal frequency division multiplex (OFDM). It is conceptually different from FH, but also uses multiple carriers on a wide bandwidth to convey information data.

It should be noted that, even though the two proposed schemes improve the bandwidth efficiency of the conventional spread spectrum DS technique, the power density of the transmitted signal has to be higher than the conventional SS system to achieve a satisfactory bit error rate (BER). Nevertheless, this is not a critical problem since most of the applications for the wireless modem are short range so that the overall transmission power density is not necessarily high for other ISM band users.

Both the MOK and conventional OCDM use phase-modulated direct sequences as their orthogonal codes. One of the problems of using such sequences for MOK is that it is difficult to design a large number of sequences that are all orthogonal to each other. First of all, the number of sequences for each symbol's transmission has to be a number of 2^{M}. This is because one always uses M input information bits to choose one of the 2^{M} sequences for a symbol transmission. Only in this way, the receiver, upon receiving one of the sequences, can determine which M bits have been sent by the transmitter. For example, if one wants to transmit 11 bits per symbol, they would have to design 2¹¹=2048 orthogonal sequences. At the transmitter, every 11 input information bits can select a unique sequence out of the 2048 sequences. At the receiver, however, they would have to implement 2048 sequence matched filters, wherein each of them matches one of the 2048 sequences. The decoded data bits are determined by the matched filter that has largest filter output. This receiver complexity is currently impossible to implement. The CCK system adopted by IEEE standard employs 64 such sequences of length eight chips, which has already made the system very complicated. In a spread spectrum system, the length number directly relates to the system gain for anti-interference capability. Eight for a CCK system is considered to be very marginal. To have more of an interference protection margin, one has to increase the length and find many more sequences. This makes the system design very difficult. In addition, the system is not flexible for customer configuration.

The problem associated with the conventional OCDM is that it is very difficult to find M purely orthogonal sequences (M is any integer number). If one finds a set of such sequences, their lengths are usually not short (16 or longer for example), which results in a large degree of amplitude modulation. This is also undesirable, because it needs a very linear power amplifier to keep the transmitted signal undistorted. Besides, the long sequence will make it very difficult to achieve bandwidth efficiency, because the symbol rate is too low compared to the sequence chip rate (symbol rate is equal to the chip rate divided by the sequence length). The low symbol rate will result in low data rate, and therefore, low bandwidth efficiency.

Another problem associated with both systems is that the spectrum mask by the sequence phase modulation is not compact due to the abrupt phase change of those sequences. It always has an undesirable spectrum component beyond the defined band. Therefore, such systems need accurate hardware filters to clean up the adjacent bands.

From the above study, compared to the current MOK and OCDM schemes it would be highly desirable to have a modulation scheme which can achieve higher bandwidth efficiency, simpler implementation, better power spectrum, and larger anti-interference capability. Moreover, it would be also desirable that the system parameters such as data rate, bandwidth, and anti-interference gain, can be easily configured by customers according to their applications.

The related art is represented by the following patents of interest.

U.S. Pat. No. 1,754,882, issued on Apr. 15, 1930 to Edward E. Clement, describes the transmission of intelligence by means of polyphase currents. U.S. Pat. No. 2,422,664, issued on Jun. 24, 1947 to Carl B. H. Feldman, describes methods and systems for modulating the frequency of a continuous wave of radiant energy over a wide band intermittently in a saw-tooth manner in accordance with the signals to be transmitted. Feldman does not utilize the orthogonality of chirp sequences and thus does not belong to multi-dimension modulation.

U.S. Pat. No. 2,817,828, issued on Dec. 24, 1957 to John H. McGuigan et al., describes a multifrequency high speed signaling system employing pulses of signaling currents of predetermined duration based on orthogonal functions. U.S. Pat. No. 2,956,128, issued on Oct. 11, 1960 to Cassius C. Cutler, describes heterodyne systems employing trains of pulses.

U.S. Pat. No. 3,484,693, issued on Dec. 16, 1969 to Kouan Fong, describes a frequency shifted sliding tone analog data communication system. U.S. Pat. No. 3,766,477, issued on Oct. 16, 1973 to Charles E. Cook, describes an apparatus for providing a total number of linear FM signals within a bounded time-frequency region which meet a specific cross-talk requirement in a communication system.

U.S. Pat. No. 5,084,901, issued on Jan. 28, 1992 to Yasuo Nagazumi, describes a sequential chirp modulation-type spread spectrum communication system. U.S. Pat. No. 5,263,046, issued on Nov. 16, 1993 to James E. Vander Mey, describes a chirp spread-spectrum communication system with a sharply defined bandwidth.

U.S. Pat. No. 5,274,667, issued on Dec. 28, 1993 to David Olmstead, describes an adaptive data rate packet communications system. U.S. Pat. No. 5,825,810, issued on Oct. 20, 1998 to Jimmy K. Omura et al., describes a method for demodulating a received spread-spectrum signal using a minimum-shift-keyed receiver.

Japanese Patent No. 64-30340, published on Feb. 1, 1989, describes a system for multiplex communications by spread spectrum. Japan '340 does not suggest high bandwidth efficient spread spectrum modulation using chirp waveform according to the claimed invention.

None of the above inventions and patents, taken either singly or in combination, is seen to describe the instant invention as claimed.

### SUMMARY OF THE INVENTION

The present invention provides a method and apparatus for effecting the high bandwidth efficient spread spectrum modulation using chirp waveform. The method involves reducing the data rate by narrowing the bandwidth or by using a smaller set of orthogonal sequences. The apparatus includes a transmitter and a receiver. The transmitter includes an encoder, an interleaver, a serial to parallel convertor, a baseband modulator that modulates the original bits onto each orthogonal sequence, and IF modulation. The receiver includes a down converter, an analog to digital converter, digital correlators, a synchronizer, a parallel to serial convertor, a deinterleaver, and a decoder.

The high bandwidth efficient spread spectrum modulation scheme employs orthogonal sequences by OCDM. The present invention derives a perfect set of orthogonal sequences for such use. The derived sequences are fundamentally different from the phase modulated sequences. They are frequency modulated sequences with very smooth phase variation during the sequence.

In accordance with one aspect of the present invention, a novel signal structure is shown in which a set of frequency chirping waveforms are used to form the orthogonal sequences. The signal modulated by these sequences has much better smoothed spectrum due to their non-abrupt phase variation. At the same time, these sequences also provide the spread spectrum gain to combat interference just like what the phase modulated sequences do.

In accordance with another aspect of the present invention, the derived orthogonal sequences can be any integer number, instead of some limited numbers as the phase modulated sequences have. This freedom of choosing the number of sequences creates significant flexibility for system configuration and makes it possible for the maximum bandwidth efficient transmission. In fact, with better anti-interference capability, the invented modulation scheme can easily double the throughput of existing modulations.

In accordance with yet another aspect of the present invention, unlike the DS SS systems in which all of the orthogonal sequences occupy the same bandwidth, each of the derived sequences has its own unique center frequency, which can be viewed as an orthogonal frequency division multiplex (OFDM) scheme with spread spectrum on each carrier. In this aspect, the high speed data stream is split into many low speed sub-streams, each of them are modulated on different spread spectrum frequency carriers. This improves the transmission performance in multipath channel because the delay spread become insignificant relative the symbol duration.

The present invention provides significant advantages over the existing technologies in terms of higher bandwidth efficiency, larger degree of flexibility in system configuration, more robust communication in interference environment, and cleaner transmission spectrum.

Accordingly, it is a principal object of the invention to provide a high bandwidth efficient spread spectrum modulation using chirp waveform.

It is another object of the invention to provide a transmitter for effecting a high bandwidth efficient spread spectrum modulation using chirp waveform including an encoder, an interleaver, a serial to parallel convertor, a baseband modulator that modulates the original bits onto each orthogonal sequence, and IF modulation.

It is a further object of the invention to provide a receiver for effecting a high bandwidth efficient spread spectrum modulation using chirp waveform that includes a down converter, an analog to digital converter, digital correlators, a synchronizer, a parallel to serial convertor, a deinterleaver, and a decoder.

It is an object of the invention to provide improved elements and arrangements thereof in an apparatus for effecting a high bandwidth efficient spread spectrum modulation using chirp waveform for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 illustrates the instantaneous frequencies of the proposed carriers during a symbol transmission period [kT, (k+1) T] with τε[0, T] as a parameter for selecting different carrier.

FIG. 2 plots two of the waveforms, wherein both their in-phase (I) and quadrature (Q) parts are plotted, and the two carriers are orthogonal.

FIG. 3 shows the relationship between symbol duration and the system processing gain G when the system bandwidth (single side) B is fixed.

FIG. 4 is the relationship between the information bit rate and the system bandwidth 2B for a QPSK modulated system.

FIG. 5 is a block diagram of the transmitter system according to the invention.

FIG. 6 is a block diagram of the receiver system according to the invention.

FIG. 7 compares the power spectrum density of the proposed signal compared with a conventional DS SS signal.

Similar reference characters denote corresponding features consistently throughout the attached drawings.

### DETAILED DESCRIPTION OF THE PREFERRED EMBODIMENTS

The present invention provides a method and apparatus for effecting high bandwidth efficient spread spectrum modulation using chirp waveform. The method involves reducing the data rate by narrowing the bandwidth or by using a smaller set of orthogonal sequences. The apparatus includes a transmitter and a receiver. The transmitter includes an encoder, an interleaver, a serial to parallel convertor, a baseband modulator that modulates the original bits onto each orthogonal sequence, and IF modulation. The receiver includes a down converter, an analog to digital converter, digital correlators, a synchronizer, a parallel to serial convertor, a deinterleaver, and a decoder.

The invention disclosed herein is, of course, susceptible of embodiment in many different forms. Shown in the drawings and described hereinbelow in detail is a preferred embodiment of the invention. It is to be understood, however, that the present disclosure is an exemplification of the principles of the invention and does not limit the invention to the illustrated embodiment.

Spread spectrum technology has been widely used in both wireless and wireline communications, such as IS-95 CDMA cellular and the third generation digital cellular, ISM band wireless modems, direct subscribe line systems, and power line data transmissions. The major advantage of spread spectrum is its capability to combat various types of channel impairment. These systems either use phase modulated (linear) sequences, the so-called direct sequence (DS) for spectrum spreading, or use multiple tone carriers as in frequency hopping (FH) systems and orthogonal frequency division multiplex (OFDM) systems. To the knowledge of this inventor, no one has designed a spread spectrum system which makes use of frequency chirp modulated (non-linear) sequences for OCDM modulation, though many inventions have used a chirp signal for the sole purpose of spread spectrum. Single chirp waveform has been used in radar detection for a long time. But its use is limited only to the measurement of the time difference between a transmitted chirp pulse and the reflected chirp pulse from an object due to its high time resolution capability. In this invention, a set of chirp sequences is theoretically derived. The derived sequences can be easily used to carry information data bits in a much more efficient way compared to the systems that use any other linear sequences. Following are the details of the invention.

First of all, a chirp waveform is defined from time 0 to time T as

S(t,τ)=e^{jπμ(t-τ)}^{²}p(t) (1)

where

$$p ( t ) = \{ \begin{matrix}1 & 0 \leq t \leq T \\ 0 & otherwise\end{matrix} \qquad ( 2 )$$

T represents the symbol duration of the data transmission, μ is a constant, and τ is a parameter. Our goal is to find some waveforms with a different parameter τ, so that these waveforms are orthogonal. With a set of orthogonal sequences, one can modulate information bits onto these sequences. Therefore, one can carry more bits of the information for each symbol of duration T. The phase of the above defined signal in [0, T] is given by

φ(t,τ)=πμ(t−τ)² (3)

Thus, the instantaneous frequency of the signal is written as

$$f ( t , τ ) = \frac{1}{2 π} \frac{ⅆ φ t}{ⅆ t} = μ ( t - τ ) \qquad ( 4 )$$

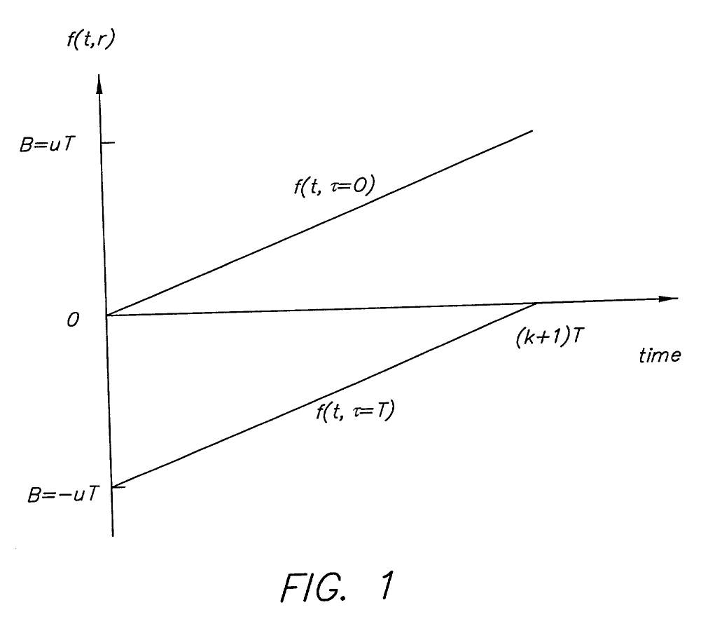

Depending on the value of τ, the frequency will swing from −μτ, when t=0, to μ(T−τ), when t=T. If τ is constrained in [0, T], the frequency will be limited in −μT to μT. If B=μT, the defined signal occupies the frequency from −B to B. For convenience, B is called the system single-side bandwidth and 2B the double-side bandwidth. FIG. 1 shows the instantaneous frequency in [0, T] with τ=0 and τ=T. It is seen that each carrier only scans a bandwidth of B and all the carriers span on a double-side band of 2B. It is clear that the frequency of S(t,τ=0) is shown as the upper line linearly swings from 0 to B, and the frequency of S(t, τ=T) is shown as the lower line swings from −B to 0. The frequencies with other τ in between 0 and T are also linear and fall inside the two lines with the same slope.

Now, given the system single-side bandwidth B, can some waveforms be found with different τ that are orthogonal to each other? If so, how many of them are there? Assuming there are two waveforms S(t, τ₁) and S(t, τ₂), the correlation of them is given by

$$\begin{matrix}ρ ( Δ t ) = ρ ( {τ}_{2} - {τ}_{1} ) = \frac{1}{t} {\int }_{- ∞}^{∞} S ( t , {τ}_{1} ) {S}^{*} ( t , {τ}_{2} ) ⅆ t \\ = \frac{1}{T} {\int }_{0}^{T} {ⅇ}^{{jπμ ( t - {τ}_{1} )}^{2}} {ⅇ}^{- {jπμ ( t - {τ}_{2} )}^{2}} ⅆ t \\ = {ⅇ}^{jπμ ( {τ}_{2}^{2} - {τ}_{1}^{2} )} {ⅇ}^{jπ B} \frac{sin ( π B Δ τ )}{π B Δ τ}\end{matrix} \qquad ( 5 )$$

From this equation, if BΔτ=k, k is an integer, p(Δτ)=0. This is to say that, if Δτ is at least 1/B or a multiple of 1/B, the two waveforms have zero cross-correlation. Since τ=0 to T for the system single-side bandwidth B, it is found that the maximum number of the orthogonal waveforms is given by T/(1/B)=TB. G=TB is called the system time-bandwidth product. In fact, the system symbol transmission rate R_{S} is equal to 1/T. Therefore,

G=B/R_{S} ,(6)

which is the ratio of the transmitted signal bandwidth to the symbol rate. Theoretically, this is the processing gain of the spread spectrum system. In the linear modulation direct sequence spread spectrum system, the processing gain is exactly the same as the above equation. However, for the invented system, the number of orthogonal waveforms is equal to the processing gain G. (Here it is assumed that G is an integer. If not, the number of orthogonal waveforms is the integer part of G). This feature of the invented system has a great advantage over the linear modulation systems, because other systems cannot easily find G orthogonal waveforms if the processing gain G is any number, such as 10, 11, 12, 13, 14, etc. The linear modulated systems can find enough quasi-orthogonal waveforms if G is 8, 16, 32 or so on. But these numbers will often make system design and implementation difficult and result in less bandwidth efficiency.

Defining a set of orthogonal waveforms as

$${S}_{i} ( t ) = {ⅇ}^{{jπμ ( t - \frac{i - 0.5}{B} )}^{2}} p ( t ) , i = 0 , 1 , … , G - 1 \qquad ( 7 )$$

we have

$$\frac{1}{T} {\int }_{0}^{T} {S}_{i} ( t ) {S}_{j}^{*} ( t ) ⅆ t = \{ \begin{matrix}1 & i = j \\ 0 & i \neq j\end{matrix} \qquad ( 8 )$$

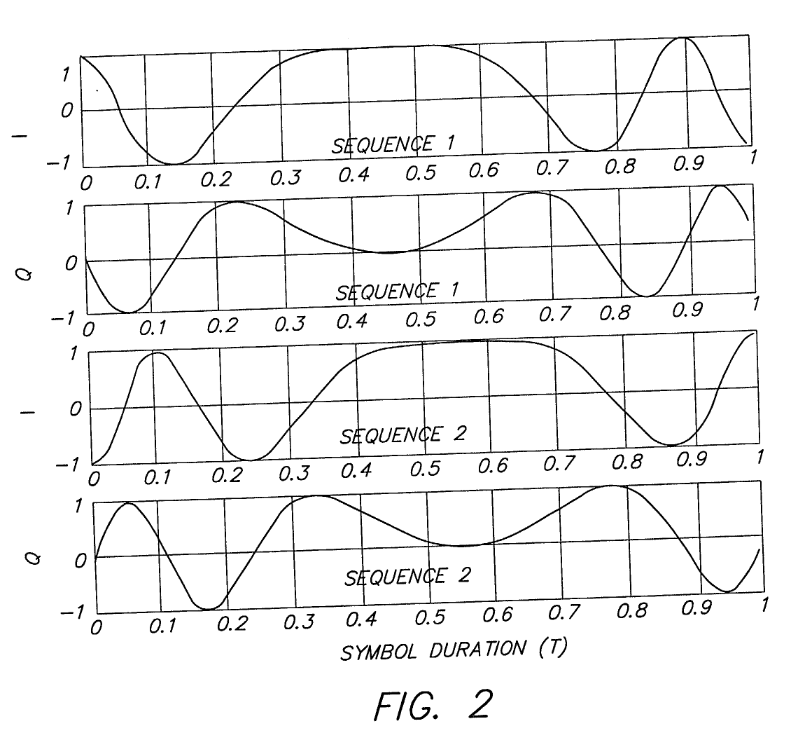

These G waveforms (or sequences for discrete version) can be used to send information bits by modulating information on each of the sequences. FIG. 2 shows two such sequences when G=10. Note for each sequence, both its in-phase and quadrature components are plotted. The two carriers are orthogonal. Unlike the direct sequences, these sequences have continuous phase instead of discontinuous phase.

The modulation scheme can be as simple as BPSK, QPSK, or as complicated as QAM. By using QPSK, which are used in most other linear modulation schemes, each sequence for a symbol of length T can carry two bits of information, and G sequences can carry 2G information bits. Mathematically, the transmitted signal is the summation of these modulated sequences, which is

$${S}_{TX} ( t ) = {\sum }_{i = 1}^{G} {A}_{i} ( k ) {ⅇ}^{{jφ}_{1} ( k )} \cdot {S}_{i} ( t - kT ) \qquad ( 9 )$$

where φᵢ (k) and Aᵢ (k) represent the phase and amplitude of modulated information in the kth symbol of the ith sequence, respectively.

At the receiver, if it is desirable to decode the information on the ith sequence, the received signal can be correlated, which can be simplified as the attenuated transmitted signal plus noise, with each conjugated sequence. The correlator output is then

$$\begin{matrix}{C}_{i} ( k ) = α {\int }_{kT}^{( k + 1 ) T} {S}_{TX} ( t ) \cdot {S}_{i}^{*} ( t ) ⅆ t + {\int }_{kT}^{( k + 1 ) T} n ( t ) \cdot {S}_{i}^{*} ( t ) ⅆ t \\ = α \cdot {A}_{i} ( k ) {ⅇ}^{jφ ( k )} {\int }_{kT}^{( k + 1 ) T} {S}_{i} ( t - kT ) \cdot {S}_{i}^{*} ( t ) ⅆ t + \\ α {\int }_{kT}^{( k + 1 ) T} {\sum }_{m \neq i}^{} {A}_{m} ( k ) {ⅇ}^{{jφ}_{m} ( k )} {S}_{m} ( t - kT ) \cdot {S}_{i}^{*} ( t ) ⅆ t + \\ {\int }_{kT}^{( k + 1 ) T} n ( t ) \cdot {S}_{i}^{*} ( t ) ⅆ t = α \cdot {A}_{i} ( k ) {ⅇ}^{jφ ( k )} + N ( t )\end{matrix} \qquad ( 10 )$$

since Sᵢ(t−kT)=Sᵢ (t), i.e. the sequences are periodically used for each symbol. Obviously, the correlator output contains the transmitted information on the amplitude Aᵢ (k) and phase φᵢ (k) and some noise. By looking at its constellation point, we can easily demodulate the information bits.

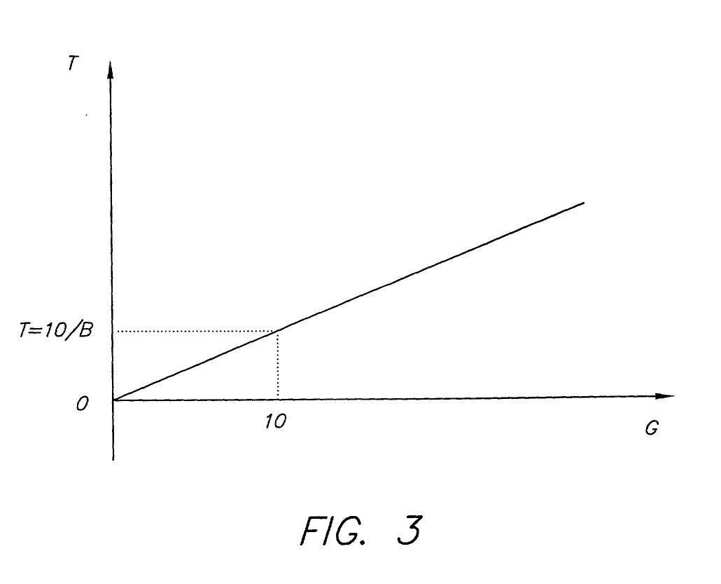

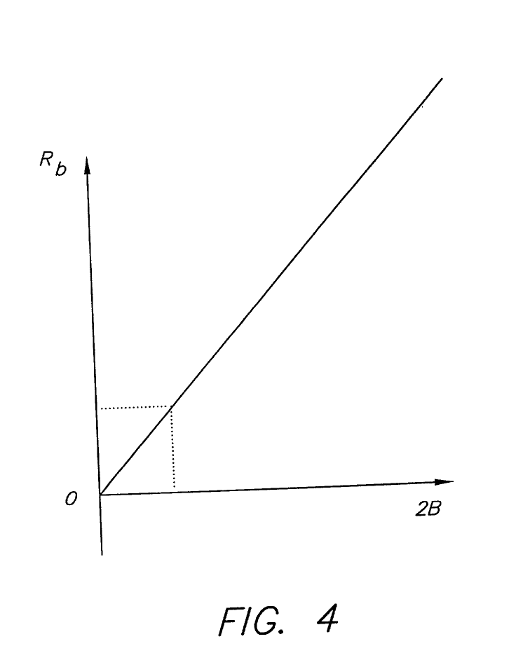

When Aᵢ (k) is a constant and φᵢ (k) has four phases such as ±π/4 and ±3π/4, the modulation on each sequence is QPSK. For such a QPSK system, when G such correlators are built in the receiver, wherein each of them corresponds to a different sequence, the 2G bits for each symbol can be demodulated. Since G=BT, R_{S}=1/T=B/G, which means, for a given bandwidth B, more or less symbols per second can be transmitted by selecting a different processing gain G. The smallest number for G is 1, which means, the system does not have spread spectrum processing gain or the symbol rate is equal to the bandwidth B, and the system only has one sequence available. This is actually equivalent to the conventional pulsed shaped narrow-band phase modulation system, except its symbol pulse is defined by the frequency modulated waveform. The inventive system does not intend to let G=1. When G>1, the symbol rate starts to reduce, because B is fixed. A larger G will provide better resistance to interference. FIG. 3 draws the relationship between the symbol duration and the processing gain G given a system bandwidth B. From this figure, it is seen that the system processing gain can be increased by increasing the symbol duration or reducing the symbol rate as in the DS system. However, this does not mean that the information rate has to be reduced when more processing gain is desired. The information bit rate R_{b} of the invented modulation scheme is R_{b}=2G·R_{S}=2G·B/G=2B for the QPSK system, which is only a function of B. Actually, the system bandwidth efficiency is R_{b}/2B=1 bit/second/Hz. FIG. 4 illustrates the relationship between the information bit rate and the bandwidth 2B for a QPSK modulated system. The slope is the system bandwidth efficiency in bits/second/Hz. It is clear that the system efficiency or bit per second per Hz is 1, which does not change with the bandwidth. A high data rate user will require more bandwidth than a low data rate user. So it is a bandwidth-on-demand system. In contrast, in the CCK system, a low data rate user occupies the same bandwidth as that of a high data rate user does, which wastes a lot of bandwidth.

Since changing G does not affect the information bit rate, it may be desirable to make G as large as possible. However, a large G means that many more correlators are needed in the receiver, which increases the system complexity. Besides, a larger G can also increase the amplitude variation, which is not desirable.

It should be noted that this invented modulation can also use a subset of the total G sequences. In this way, the overall power spectrum density (PSD) will be reduced for the same BER performance. However, it is also less bandwidth efficient since the number of information bits carried by a symbol is reduced. In exchange, it can offer more robust communication in a multipath channel. In summary, the invented modulation offers two ways to reduce the transmission rate. One way is to reduce the data rate by narrowing the bandwidth B. This will keep the maximum transmission efficiency. The other way is by using a smaller set of orthogonal sequences. This will reduce the PSD and the amplitude modulation, but will also reduce the transmission efficiency. This flexibility makes it possible to design more or less independent user channels for a given band. A careful selection of the number of the sub sequences and the bandwidth will result in the most robust and efficient system for a specific application.

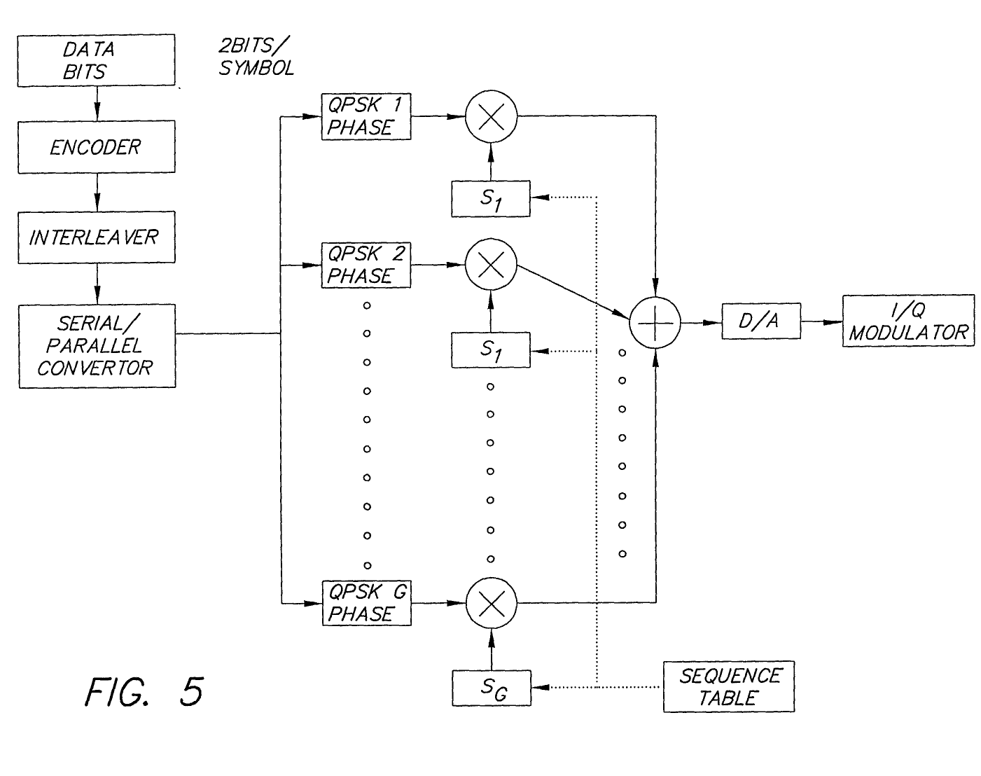

Implementation of the invented modulation scheme is very straightforward. FIG. 5 shows the block diagram of the transmitter including the encoder, interleaver, baseband modulator that modulates the original bits onto each orthogonal sequence, and IF modulation. A lookup table provides all the orthogonal sequences for modulation with the information bits. After an I and Q upconverter, the signal can be further upconverted to an RF frequency for radio transmission, or amplified for wireline or other media transmission. For the purpose of synchronization, one sequence for frequency, time, and phase estimation at the receiver is exclusively employed. The IF signal can be further modulated onto any frequencies for wireless or wireline transmission.

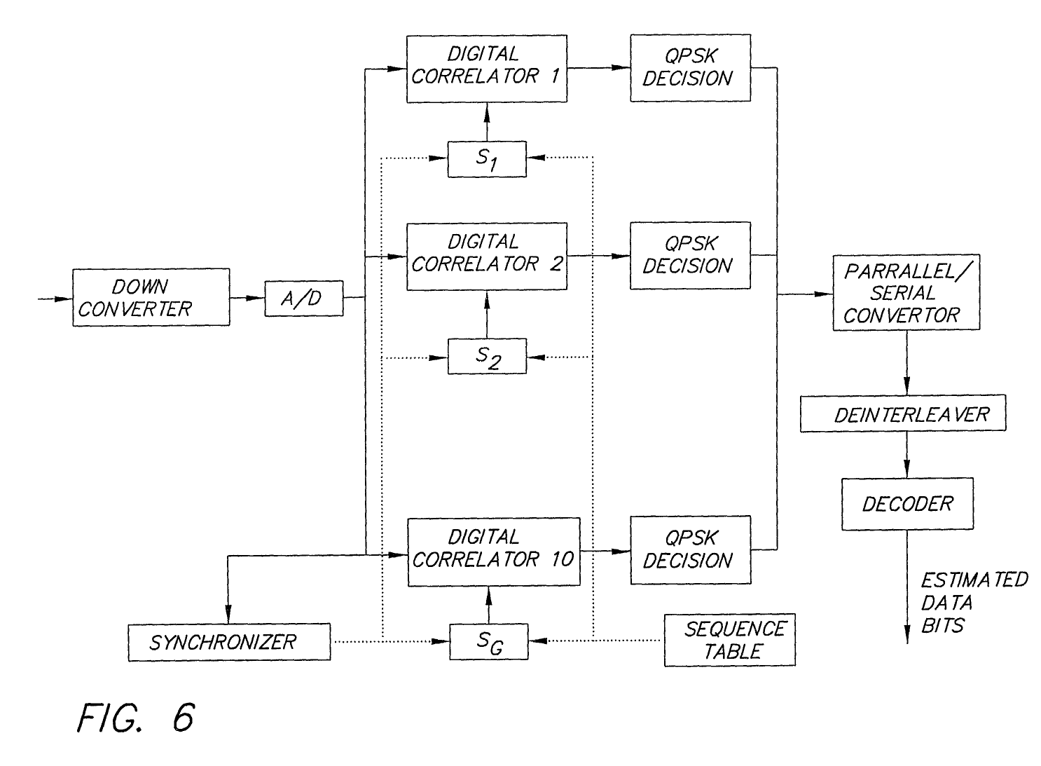

The receiver shown in FIG. 6 is basically the reverse operation of the transmitter, along with a synchronizer. The received signal is down-converted to baseband and digitized. Then the digitized signal is sent to the bank of the correlators. The outputs of the correlators are QPSK demodulated to form the input to the decoder. The synchronization circuit provides time, frequency and possibly phase (if coherent demodulation is used) estimates on the received signal so that the demodulation becomes possible. The synchronizer measures the pilot sequence's frequency, time, and phase. The demodulator employs a bank of sequence correlators. The output of these correlators are further QPSK demodulated (coherently or non-coherently) to obtain the interleaved bits. These bits are de-interleaved and decoded to recover the transmitted information bits.

Comparison with existing technologies

Existing spread spectrum modulation schemes are DS modulation and FH modulation. For FH modulation systems, one can also apply the OCDM technique to the frequency hopping patterns. In this way, more hopping frequencies can be transmitted at the same time without interfering each other. This increases the information transmission rate, thus increasing the bandwidth efficiency. In fact, the OCDM FH modulation will be no different from the OFDM modulation. The invented modulation is similar to OFDM in the sense that they all use multiple frequency carriers. However, the carriers of the two systems are fundamentally different. The carriers of OFDM are a number of non-overlapping frequency tones, while the invented carriers are a number of overlapped spread spectrum carriers with different center frequencies. These spread spectrum carriers have much better anti-interference capability than single tone carriers have. Another difference between the two is that the OFDM system uses very complex IFFT and FFT algorithms for modulation and demodulation. The invented system uses straightforward correlation algorithm.

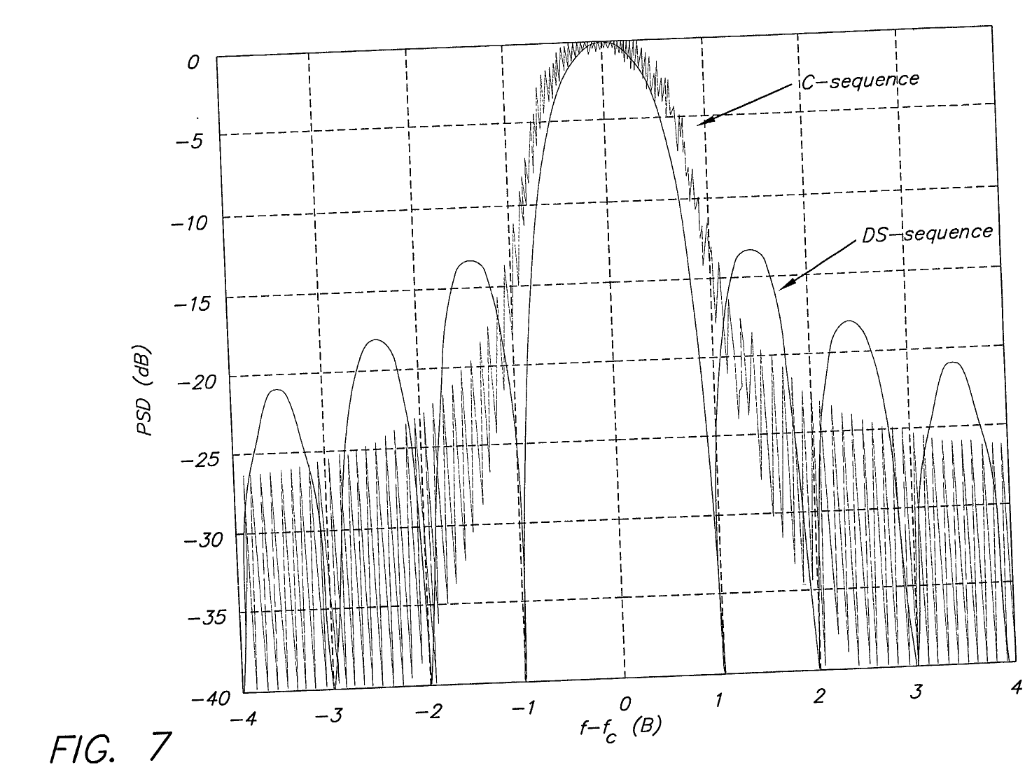

DS SS based bandwidth efficient modulation schemes require to find enough phase modulated orthogonal codes. This is usually not an easy task. Even though, there are many orthogonal sequences available, but their lengths (number of chips per sequence) cannot be any number. This makes the implementation of bandwidth efficient modulation difficult. In addition, in a lot of cases, those sequences are not strictly orthogonal. For example, the cyclic Barker code of 11 chips are not strictly orthogonal. The length of m-sequence and Gold sequence have to be 2^{m}−1. The Walsh code has to be in the length of 2^{m}. For DS system, the length of codes defines the processing gain. These numbers for the length of codes are not flexible enough to adjust the processing gain and to achieve the maximum efficiency of transmission. In contrast, the invented technology has complete freedom to adjust the processing gain without sacrificing the transmission efficiency. In addition, the invented modulated signal has better spectrum than that of the DS modulated signal. In FIG. 7, the spectrum of the invented signal is spread more evenly in −B to B, and decays much more quickly outside the band. The DS signal has less evenly spread spectrum in −B to B and much stronger spectrum components outside the bandwidth. Extra filtering has to be used for the DS system to reduce the out of band spectrum in order to reduce interference to adjacent channels.

The spread spectrum bandwidth efficient modulation presented in this disclosure derives a set of perfect orthogonal signal sequences from chirp waveform. These chirp sequences offer significant advantages over any existing bandwidth efficient spread spectrum modulation schemes in terms of higher bandwidth efficiency, flexible system configuration, simpler transmitter and receiver implementation, higher processing gain if necessary, cleaner signal spectrum. The developed modulation scheme can be used in wireless modem in applications such as WLAN, Bluetooth, home networking and cellular data, wireline data transmission such as data transmission on power line, cable modem, direct subscribe line, and fiber optical.

It is to be understood that the present invention is not limited to the sole embodiments described above, but encompasses any and all embodiments within the scope of the following claims.

I claim:

1. A high bandwidth efficient method for spread spectrum modulation using a chirp waveform, comprising the steps of:
(a) encoding an information data signal, the encoded signal having a plurality of symbols encoded at a symbol rate, each symbol having a symbol duration;
(b) splitting the information data signal into a plurality of parallel information data signals using a serial to parallel converter;
(c) generating a plurality of orthogonal chirp waveforms which are orthogonal in frequency;
(d) modulating said plurality of parallel information data signals with said plurality of orthogonal chirp waveforms in order to produce a plurality of parallel information data signals modulated on orthogonal chirp waveforms;
(e) combining said plurality of plurality of parallel information data signals modulated on orthogonal chirp waveforms to produce a combined waveform; and
(f) transmitting said combined waveform.

2. The high bandwidth efficient method according to claim 1, wherein step (d) further comprises modulating said plurality of parallel information data signals with said plurality of orthogonal chirp waveforms using binary phase shift keying.

3. The high bandwidth efficient method according to claim 1, wherein step (d) further comprises modulating said plurality of parallel information data signals with said plurality of orthogonal chirp waveforms using quadrature phase shift keying.

4. The high bandwidth efficient method according to claim 1, wherein step (d) further comprises modulating said plurality of parallel information data signals with said plurality of orthogonal chirp waveforms using quadrature amplitude modulation.

5. The high bandwidth efficient method according to claim 4, wherein one of said plurality of orthogonal waveforms is modulated with frequency, time, and phase estimation data for synchronization.

6. The high bandwidth efficient method according to claim 1, further comprising the step of modulating said combined waveform with a radio frequency carrier before step (f).

7. The high bandwidth efficient method according to claim 1, further comprising the step of amplifying said combined waveform for transmission over wireline before step (f).

8. The high bandwidth efficient method according to claim 1, further comprising the step of increasing symbol duration while keeping bandwidth constant, whereby system gain is increased while information rate is constant.

9. The high bandwidth efficient method according to claim 1, further comprising the step of reducing the symbol rate while keeping bandwidth constant, whereby system gain is increased while information rate is constant.

10. The high bandwidth efficient method according to claim 1, wherein step (c) further comprises generating a plurality of orthogonal waveforms which is fewer in number than the product off the bandwidth times the symbol duration, whereby power spectrum density is decreased without deterioration in bit error rate.

11. The high bandwidth efficient method according to claim 1, wherein step (c) further comprises generating a plurality of orthogonal waveforms equal in number to the spread spectrum processing gain, or the time-bandwidth product BT.

12. The high bandwidth efficient method according to claim 1, wherein each said orthogonal chirp waveform comprises a sequence of discrete values defining a chirp waveform, said plurality of sequences being orthogonal to each other.

13. A high bandwidth efficient spread spectrum modulation system using a chirp waveform, comprising:
(a) at least one transmitter having:
(i) an encoder for encoding an information data signal;
(ii) an interleaver connected to said encoder for interleaving the information data signal;
(iii) a serial to parallel convertor connected to said interleaver for converting said information data signal into a plurality of parallel information data signals;
(iv) a plurality of stored orthogonal sequences, each sequence defining a chirp waveform;
(v) modulation means for modulating said plurality of orthogonal sequences with said plurality of parallel information data signals;
(vi) a combiner connected to said modulation means for combining said modulated parallel information data signals in order to define a combined signal; and
(vii) means for transmitting said combined signal; and
(b) at least one receiver having:
(i) means for receiving said combined signal;
(ii) at least one storage device having said plurality of orthogonal sequences stored therein;
(iii) demodulation means for demodulating said combined signal using the plurality of orthogonal sequences stored in said storage device
(iv) a parallel to serial converter connected to said demodulation means;
(v) a deinterleaver connected to said parallel to serial converter for deinterleaving the demodulated serial signal; and
(vi) a decoder connected to said de-interleaver for decoding the received signal in order to reproduce the information data signal.

14. The high bandwidth efficient spread spectrum modulation system according to claim 13, wherein:
(a) said modulation means comprises a plurality of quadrature phase modulation circuits; and
(b) said demodulation means comprises a plurality of correlators.
